(19) United States
(12) Patent Application Publication
(10) Pub. No.: US 2002/0107752 A1
(43) Pub. Date: Aug. 8, 2002

(54) System and method for integrating web-originated orders with backend business systems

(76) Inventors: Gustavo R. Rivera, Boulder, CO (US); Delbert Lee McKinney, Boulder, CO (US); Greg Lems, Lafayette, CO (US); Albert Prast, Winterpark, FL (US); Kevin S. Kelm, Timnath, CO (US); Jonathan David Sharley, Westminster, CO (US); Barry Neu, Longmont, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/810,753

(22) Filed: Mar. 16, 2001

Related U.S. Application Data
(60) Provisional application No. 60/267,447, filed on Feb. 8, 2001.

(51) Int. Cl. G06F 17/60

(52) U.S. Cl. 705/26

(57) ABSTRACT

A method for managing orders placed at an electronic commerce site is described. In one embodiment, a purchase order is received from the electronic format. The purchase order is then converted to a buyer-native-format and electronically provided to the buyer's backend accounting system.

### PRIORITY

This application claims priority from provisional patent application No. 60/267,447, filed on Feb. 8, 2001, entitled Electronic Data Exchange Standardization Protocol, and provisional patent application No. ______, filed on Feb. 27, 2001, entitled Systems and Methods for Data Integration Brokerage, both of which are expressly incorporated by reference.

### RELATED APPLICATIONS

The following applications are related to the present application and are hereby expressly incorporated by reference.

1) Attorney Docket No. COVA-001/00US, entitled Data Management System and Method for Integrating Non-Homogenous Systems, filed on Mar. 16, 2001; and

2) Attorney Docket No. COVA-003/00US, entitled System and Method for Rendering Documents in a User-Familiar Format, filed on Mar. 16, 2001.

### FIELD OF THE INVENTION

The present invention generally relates to data management systems. In particular, but not by way of limitation, the present invention relates to systems and methods for archiving, processing, formatting, and distributing data between non-homogenous systems.

### BACKGROUND OF THE INVENTION

Suppliers and their trading partners are constantly exchanging purchase orders, invoices, order acknowledgements and similar business documents. Depending upon the sophistication of the parties involved, different, non-compatible systems and protocols may be involved in the generation and exchange of these documents. Common systems, however, have the buyers generating purchase orders on their own systems and faxing, emailing, mailing or telephoning the purchase orders to the appropriate supplier. The supplier is then forced to manually enter the details of the received purchase order into its own system and generate a corresponding order acknowledgement and invoice for the buyer. Even though the order acknowledgement and invoice documents may be electronically generated by the supplier's backend system, these documents are often sent through the mail or faxed from the supplier to the buyer. Thus, the buyer receives the order acknowledgement and invoice in a physical form that requires the buyer to manually reenter the information from these documents into its backend system.

Buyers and suppliers (collectively called “trading partners”), in this type of common system, are continually forced to reenter data previously entered by the other party. (The term “trading partners” can also refer to any applications, systems, or networks of systems that exchange data of any type.) The supplier, for example, is forced to reenter purchase order data into its own backend system that is otherwise electronically stored at the buyer's backend system. Similarly, the buyer is forced to reenter data from order acknowledgements and invoices that are stored at the supplier's backend system. As can be appreciated, the duplicative entry of data introduces additional costs and errors into the business process. Accordingly, a system that allows for the efficient transfer of business data without manual reentry thereof is needed.

Although the above-described business method is still in widespread use, its drawbacks encouraged major suppliers to deploy EDI (electronic data interface) based solutions which offer certain suppliers the ability to receive information electronically from their trading partners in a format that can be automatically incorporated into their backend system. These EDI implementations may or may not offer the trading partner any ability to receive documents from the supplier in a format that can be automatically integrated into the trading partner's backend system. In essence, EDI services were created for the benefit of large suppliers with multiple buyers. To do business with these large suppliers, buyers must conform their systems to the systems of the suppliers.

Although EDI services are somewhat advantageous, they suffer from serious drawbacks. For example, individual suppliers often use different variations and releases of the EDI specification. To trade with multiple suppliers, a buyer could be forced to use these multiple formats—as shown in FIG. 1. EDI implementations are, unfortunately, expensive and cumbersome because they require dedicated communication lines, special VANs (value added networks) and other customized equipment and software. Thus, EDI based deployments and their continued maintenance are generally only economically feasible for larger enterprises with significant market power. These expenses often keep smaller companies from implementing it, and even if these smaller companies could afford an implementation, many trading partners would refuse to invest in the complimentary system necessary to use that EDI. These trading partners would merely do business with another supplier or continue to use a prior ordering method such as fax, email, etc. EDI suffers from other drawbacks such as lack of flexibility and lack of adaptability to custom business processes.

EDI is available to only a fraction of today's businesses and is less than satisfactory for those to which it is available. Accordingly, a system and method are needed to enable more businesses, both small and large, to move data to and from their backend systems in a seamless, low impact fashion. Such a system and method could decrease the cost of processing and handling orders and could reduce the chance for the introduction of errors through the duplicative reentry of data. Such a system and method would also address other issues and problems known in the art.

### SUMMARY OF THE INVENTION

A system and method for exchanging data between trading partners through the incorporation of both parties' existing backend systems is disclosed. In one embodiment, a network-connected data manager is disposed between a buyer and a supplier. To place an order with the supplier, the buyer fills out a purchase order native to the buyer's backend system and provides that purchase order to the data manager rather than directly to the supplier. Depending upon the buyer's backend system, the order form can be transmitted directly to the data manager, transmitted through an adapter and bridge module, or provided through a browser-like interface.

Upon receiving the purchase order from the buyer, the data manager can extract relevant data such as document type, buyer identity, supplier identity, purchase order number, order information, security information, etc. The data manager can then retrieve a translation map and workflow instruction based upon the extracted data. Using this translation map and workflow instruction, the data manager can process the received purchase order and translate it into a neutral format, e.g., a format not necessarily native either to the supplier or to the buyer. The neutral format of the purchase order is then stored in a central database that associates the order information with the appropriate trading partner and/or document type.

Before the purchase order data is provided to the supplier, the data manager retrieves a workflow and/or a translation map associated with the supplier and converts the purchase order from the neutral format to the supplier-native format according to that translation map. This translated purchase order is then provided to the supplier's backend system, where it can be directly incorporated without the need for manual reentry of the data. The data manager can also perform independent processing and tasks responsive to the workflow.

Any responses generated by the supplier, e.g., order acknowledgements and invoices, can be provided to the data manager where they can be processed and translated from the supplier-native format to the neutral format. As previously described, the documents, which can be any kind of transaction or set of data, can then be stored and, when appropriate, translated from the neutral format to the buyer-native format and provided to the buyer, where the relevant data can be automatically incorporated into the buyer's backend system. Thus, the buyer is not forced to manually input the data from the response documents into its backend system.

In other embodiments, the present invention provides a document viewer for allowing buyers and suppliers to access documents in their native format regardless of the document's original format. For example, a supplier can access the data manager using the document viewer and view a purchase order generated by a buyer. The supplier, however, can view the purchase order in a format native to the supplier. In other words, the purchase order accessible by the supplier has a look and feel familiar to the supplier regardless of the format used by the buyer. Thus, a supplier could access all purchase orders in the same familiar format even though each of its buyers uses a different purchase order form. The document viewer can also be used for tracking, status, and data exchange between the data manager and trading partner business systems.

As can be appreciated by those skilled in the art, the present invention addresses some of the significant shortfalls in present technology as well as providing new and innovative features. In particular, the present invention, provides a flexible, low-impact system for connecting trading partners. Using the present invention, a buyer can interact in an automated fashion with many suppliers without the difficulties previously encountered with EDI. Moreover, suppliers can make their automated services available to more buyers because of the cost effectiveness and simplicity of the present invention. Other advantages and embodiments of the present invention are described more fully herein and yet other advantages and embodiments will be apparent to those of skill in the art.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a present system for enabling trading partners to exchange information;

FIG. 2 illustrates a system constructed according to the present invention that enables trading partners to exchange information;

FIG. 3 illustrates an alternate embodiment of a system for enabling trading partners to exchange information;

FIG. 4 illustrates an expanded view of the data manager and its connection with trading partners;

FIG. 5A illustrates a client integrator for connecting a backend system with a data manager;

FIG. 5B illustrates the client integrator of FIG. 5A in more detail;

FIG. 6 illustrates an integration module;

FIG. 7 illustrates one embodiment of a data manager;

FIG. 8 illustrates in more detail the communication module of the data manager shown in FIG. 7;

FIG. 9 is a flowchart of one method for operating the present invention;

FIG. 10 is a flowchart of one method for operating a document viewer; and

FIG. 11 illustrates a system for web-originated ordering in accordance with the principles of the present invention.

### DETAILED DESCRIPTION

Although the present invention is open to various modifications and alternative constructions, a preferred exemplary embodiment that is shown in the drawings is described herein in detail. It is to be understood, however, that there is no intention to limit the invention to the particular forms disclosed. One skilled in the art can recognize that there are numerous modifications, equivalents and alternative constructions that fall within the spirit and scope of the invention as expressed in the claims.

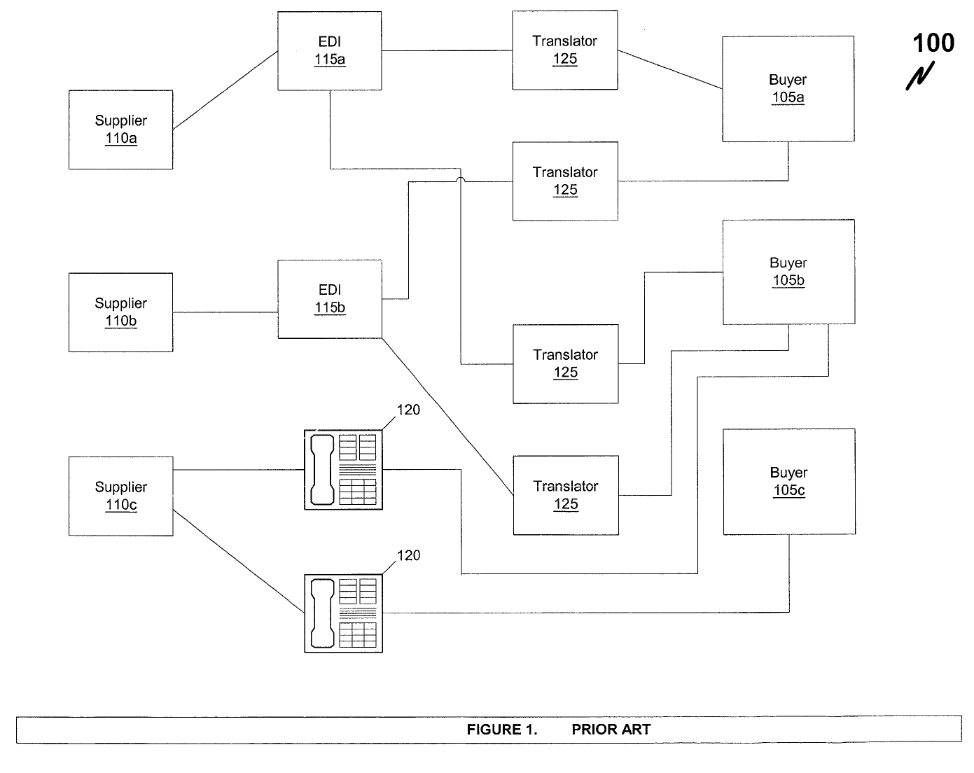

Referring first to FIG. 1, it represents a present system 100 for interfacing buyers 105 and suppliers 110 (“trading partners” as previously defined). In this system 100, suppliers 110a and 110b, for example, receive their purchase orders through multiple EDI mechanisms 115a and 115b, respectively. Suppliers 110a and 110b provide response documents, e.g., order acknowledgements and invoices, to the buyers 105a and 105b, through the EDIs 115a and 115b. Supplier 110c, unlike suppliers 110a and 110b, receives its purchase orders and sends its response documents by traditional means 120, e.g., fax, phone, email or regular mail.

As previously described, the present systems, e.g., system 100 for interfacing buyers 105 and suppliers 110 are plagued by problems. For example, if buyer 105a is to conduct business with both supplier 110a and supplier 110b, buyer 105a should have access to both EDI 115a and EDI 115b, which means that buyer 105a may be required to subscribe to two different VANs (not illustrated). Moreover, buyer 105a could need two translators 125—one for supplier 110a and one for supplier 110b—to completely interface its backend system with the supplier's backend system. Each of these translators 125 can be expensive and difficult to maintain. Furthermore, as new suppliers are added to a buyer's list of trading partners, corresponding translators must be added. At some point, the technical logistics of integrating new trading partners and the expense of such additional components become prohibitive. Therefore, larger EDI-enabled buyers or suppliers may be cost limited to integrations for only some of their trading partners and smaller buyers or suppliers are prevented from using EDI altogether.

For those trading partners that cannot justify the expense of an EDI, such as supplier 110c and buyer 105c, they must use communication methods such as phone, fax, email, mail, etc. These communication methods, as previously described, force both the buyer 105c and supplier 110c to manually reenter purchase order, order acknowledgement and invoice information. This reentry of data unnecessarily introduces additional costs and errors into the business processes.

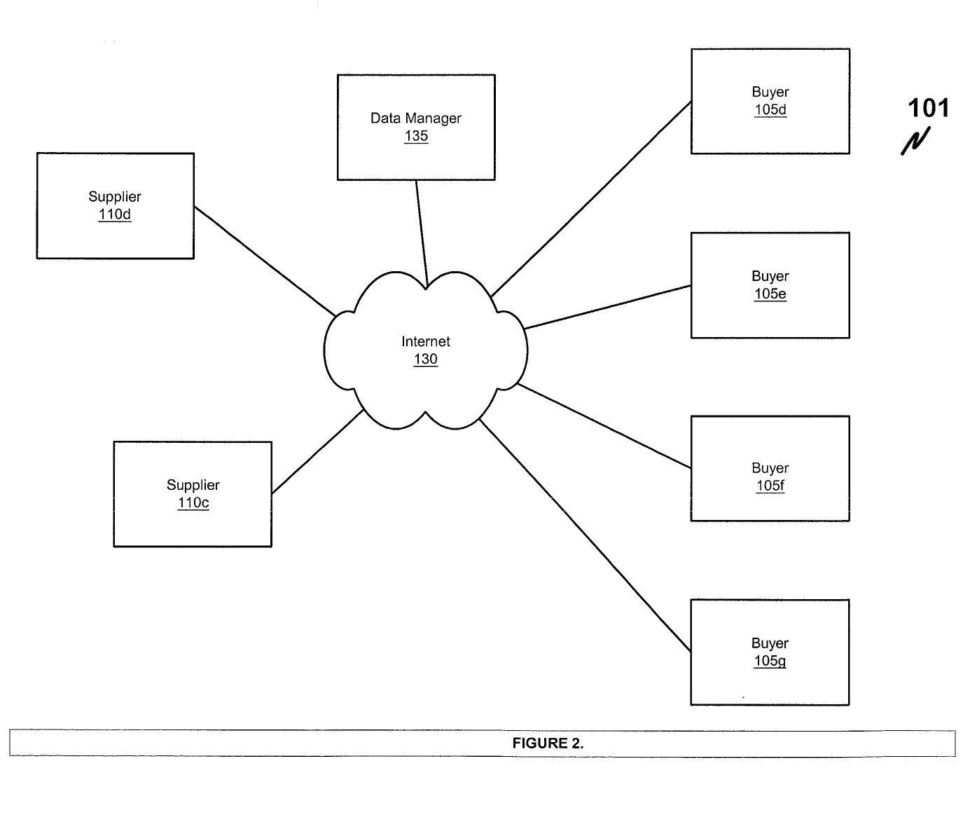

Referring now to FIG. 2, it illustrates a system 101 constructed in accordance with the principles of the present invention. In this embodiment, buyers 105 and suppliers 110 are connected by the Internet 130 to a data manager 135. The data manager 135 operates as a collection, storage, processing, workflow management and/or reporting facility for attached buyers 105 and suppliers 110. Additionally, the data manager 135 acts to process and translate data transmitted between the trading partners so that data can be received in a format native to the particular trading partner regardless of the format used by any other trading partner. Rather than having dedicated translators for each trading relationship, the present invention can centralize the processing and translation duties within the data manager 135. Furthermore, a buyer or supplier requires only a single translator, offloaded by the data manager 135, to exchange data with a trading community. Thus, the present invention can manage “any-to-any” system integration and translation in a complex “many-to-many” trading partner environment, including trading partners arranged in a multi-link supply chain. In yet another embodiment, the data manager 135 can also include the capability to broadcast data from one trading partner to many trading partners.

The data manager 135 can receive, for example, a purchase order from buyer 105d in the buyer's native format and provide the relevant data from the purchase order to supplier 110d in its native format, thereby enabling the data to be automatically available to the supplier's backend system whether it is a legacy system, an ERP (Enterprise Resource Planning) system, or any other system. Thus, the supplier 110d will not be forced to manually reenter the purchase order information into its backend system. Similarly, the data manager 135 can receive an order acknowledgement or invoice from the supplier 110d and translate that document into the proper format required by the buyer's backend system.

The present system 101 can also use the Internet 130 or other network rather than merely an expensive VAN to provide the connection between trading partners. In this Internet-enabled embodiment, trading partners need only communicate the appropriate data to the data manager 135. Any security concerns introduced by using the Internet 130 can be addressed through a variety of known methods such as SSL (secure socket layer), PKI (public key infrastructure) and digital certificates.

As can be readily appreciated, the present system 101 can reduce the need for redundant translation systems and expensive EDI implementations and maintenance. Additionally, the present system 101 presents trading partners, regardless of size, with an opportunity to automate their disparate business processes, integrate their backend systems, and reduce their costs.

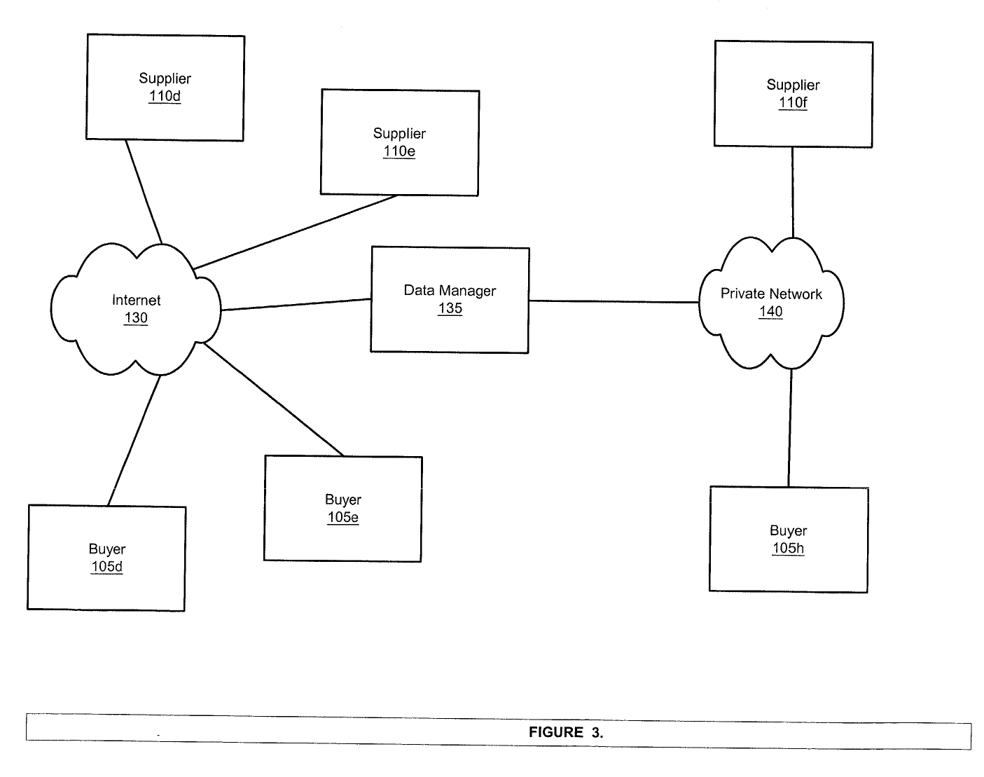

FIG. 3 illustrates an alternate embodiment of a system for connecting trading partners. In this embodiment, the data manager 135 is connected both to a private network 140 and to the Internet 130. The operation of the data manager 135 with respect to the private network 140 is generally the same as the operation of the data manager 135 with respect to the Internet 130.

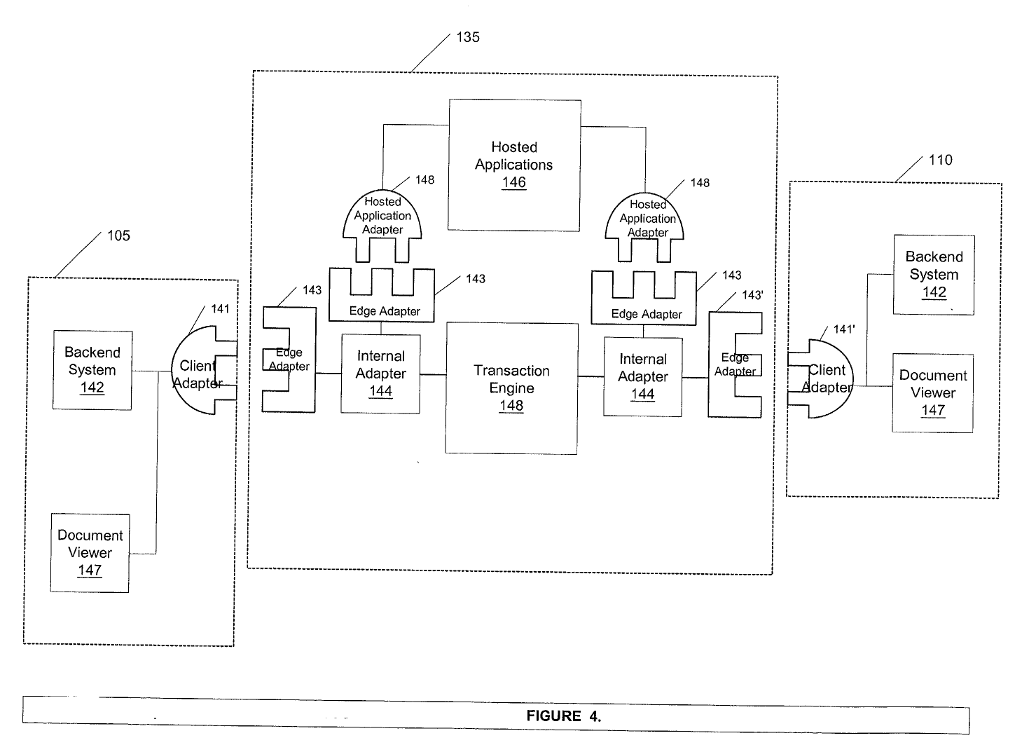

Referring now to FIG. 4, it illustrates an expanded view of the data manager 135 and its connection with the trading partners. In this embodiment, the trading partners are connected to the data manager 135 through a set of client adapters 141, which can communicate with the data manager's edge adapters 143. For example, the buyer 105 and its backend system 142 could communicate with the data manager 135 using an HTTPS protocol. (The backend system 142 can include external applications, business systems, browsers, desktop applications, etc.) The buyer's client adapter 141 would communicate with the appropriate data manager HTTPS edge adapter. Similarly, the client adapter 141′ for the supplier 110 would communicate with the appropriate edge adapter 143′, matching the communication requirements of the supplier's backend system 142′.

The edge adapters 143 interface with an extensible Application Programming Interface (called an “internal adapter”) 144, which can be a platform independent, plug-in architecture that allows new edge interfaces to be added as required. This embodiment of the internal adapter 144 communicates with the transaction engine 148 using a single interface. However, trading partners communicate through various edge adapters 143, which in turn funnel all communication to the transactional manager via the internal adapter 144. The edge adapters 143, for example, can include HTTPS, SCP (secure copy), JMS, EDI/VAN, FTP, SMTP, etc. The internal adapter 142 also can accept new “plug-in” edge interfaces 143 as new document-exchange and e-business protocol standards are published. For example, new edge adapters 143 can be developed to support Universal Description Discovery and Integration (UDDI) and Open Buying on the Internet (OBI). Because the internal adapter 144 can easily incorporate these or any other new communication methods via edge adapters, the present invention can offer significant flexibility to address changing standards while continuing to service established protocols.

Still referring to FIG. 4, the data manager 135 also includes one or more hosted applications 146 that are accessible by the trading partners. To access or exchange data, the hosted applications 146 can interface with the transaction engine 148 and the trading partners via the available set of edge adapters 143 and hosted application adapters 148. Although not meant to be an exhaustive list, hosted applications 146 may include a document viewer, client integration processes, a statistical modeler, business intelligence, system integration tools, administrative tools, and e-procurement tools.

Another innovative feature of the present invention is the document viewer 147 associated with the client-side systems. The document viewer 147 allows the trading partners to access, which includes downloading, modifying, uploading and viewing, documents stored at the data manager 135 in a familiar format. The document viewer 147, in one embodiment, presents documents using an XSL (eXtensible Stylesheet Language) template to graphically render the document with the same “look and feel” of that trading partner's corresponding paper document. Thus, the same information can be displayed differently for different trading partners and even for different individuals within a single trading partner. Furthermore, document data can be filtered to show various levels of detail based on user configuration. For example, document presentation and filtering can be configured differently at an organizational, group, or user level.

The document viewer 147 can also provide trading partners with the ability to trace entire transactions (business process) through threads that link related documents. For example, the document viewer can create and display a hierarchical arrangement of documents, e.g., a tree structure, associated with a business process. Documents can be grouped by transactions, document type, trading partner identity, document number, date, etc. In another embodiment, documents can be linked, for example, through a hypertext link, to other documents according to date, purchase order number, invoice number, document type, trading partner identity, etc.

In one embodiment, the document viewer 147 can include a hosted application 146 accessible via a web browser. To present flicker-free viewing of the relevant documents, the document viewer 147 can use a double-buffering technique. Generally, the entire graphical rendering of a document is refreshed each time a field within that document is updated in an HTML-based user interface. By refreshing the entire document, latency is increased, bandwidth requirements are increased and the overall experience for the user is less satisfactory. In the present embodiment, however, the entire graphical rendering of a document need not be refreshed each time that a field is updated because one or more hidden <IFRAME>containers perform as the communication point with the server. The main web page, thus, communicates directly with the hidden frame, which allows the server to respond to a fetch by filling the hidden frame with the appropriate script code. The hidden frame is then executed by the browser, which messages the main page with data objects to render graphical representations of the document. Data can be sent by the server to the hidden frame(s) as script code, XML (which then uses XSL to render the script code), and/or other means. Through masking, one skilled in the art could also use small <FRAME>s, which would be visual elements, to achieve similar results. Similarly, the <IFRAME>s need not be hidden, rather they could be obscured.

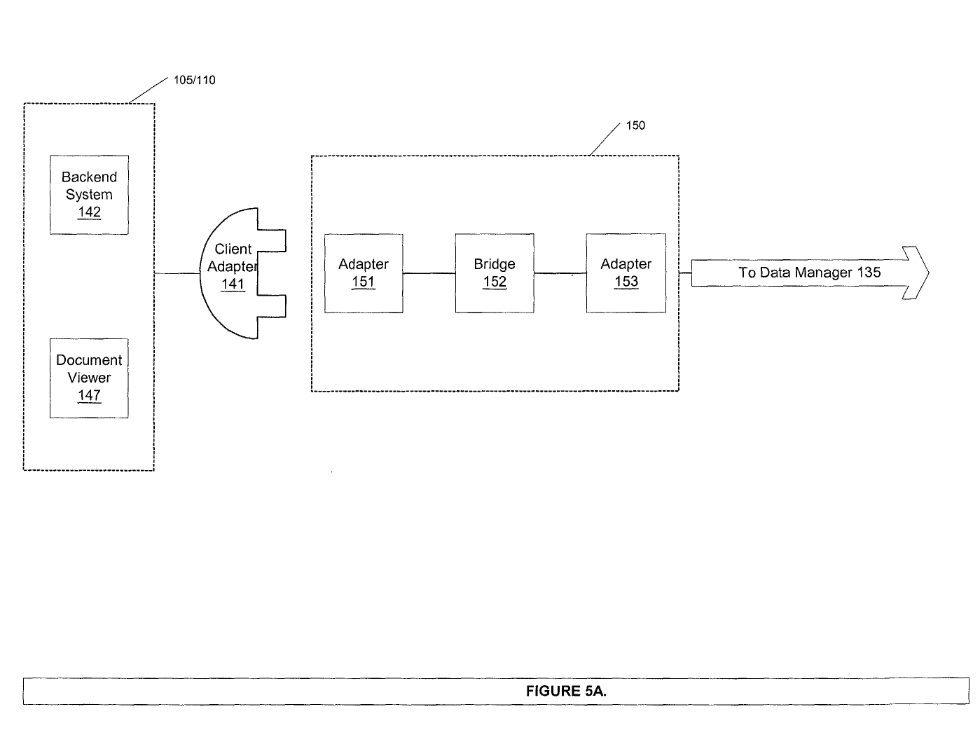

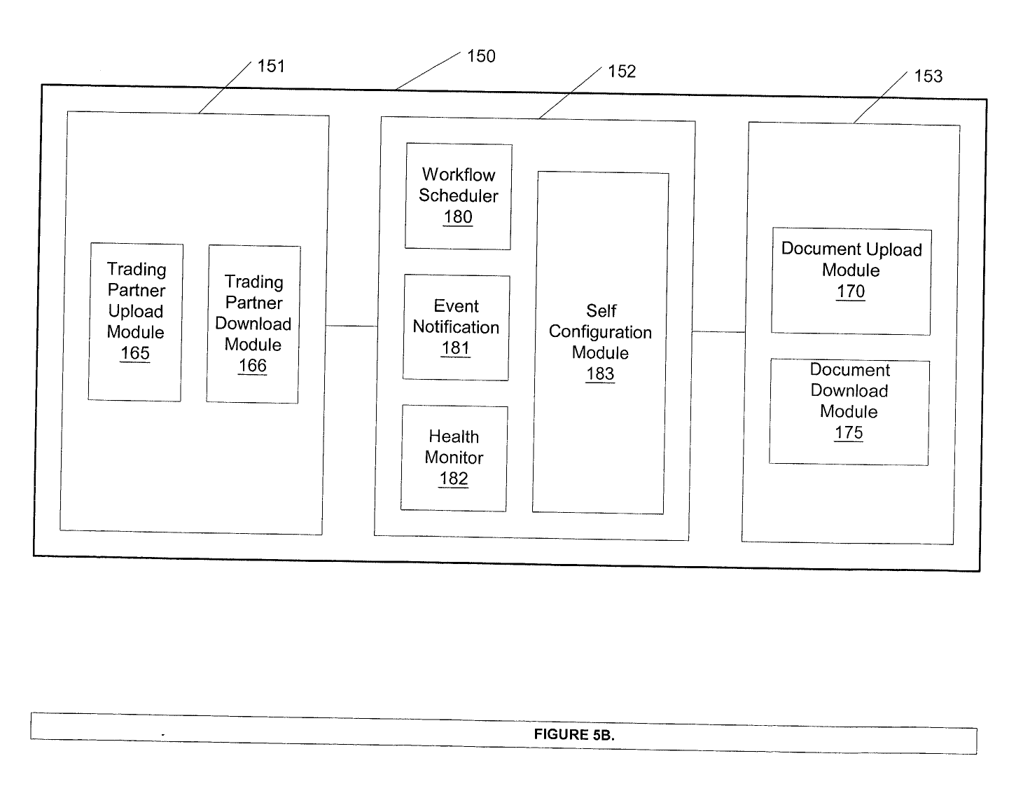

Referring now to FIG. 5A, it illustrates a client integrator 150 for connecting a backend system 142 with a data manager 135. In this embodiment, the backend system 142 does not natively support common or open data exchange interfaces. Thus, the client integrator 150 is introduced between a client adapter 141, or some other interface, and the data manager 135. In essence, the client integrator 150 acts as a communication bridge between the backend system 142 and the edge adapters 143 of the data manager 135. The client integrator 150 includes three basic modules: one or more client-side adapters 151, data manager-side adapters 153, and a bridge 152. These modules are described in more detail below.

FIG. 5B illustrates the client integrator 150 of FIG. 5A in more detail. In this embodiment, the client-side adapter 151 and the data manager-side adapter 153 each include upload and download modules 165, 166, 170, 175 configured to direct the various exchange of data types.

The bridge 152 forms the data exchange layer, workflow, and services between the various adapters that communicate with the trading partner backend system and the data manager 135. Additionally, the bridge 152 can include a workflow scheduler 180, an event notification module 181, a health monitor 182 and a self-configuration module 183. In an alternate embodiment the bridge 152 could include data processing services such as translation, encryption, and integrity checking (not diagrammed).

The data manager-side document download module 170 and upload module 175, which are incorporated into the data manager-side adapter 153, are responsible for exchanging documents with the data manager 135 and, in one embodiment, for handling errors encountered when transferring documents. The download 170 and upload modules 175 secure communications through the use of various protocols such as SSL, PKI, and digital certificates. The document download and upload modules (170 and 175) can minimize errors by automatically transferring each document atomically and by guaranteeing one time delivery. Additionally, the document download and upload modules can transfer batches of documents as required by legacy or batch processing backend systems.

The document download module 170 and upload module 175 can also communicate, e.g., poll, the data manager 135 at regular intervals, as determined by the workflow scheduler 180 or the data manager 135, to identify any new documents that are ready to be exchanged. (As those of skill in the art can understand, the trading partner upload module 165 and the trading partner download module 166 can operated similarly to the document upload 170 and document download modules 175.) For example, if the client integrator 150 is associated with supplier 110d (shown in FIG. 2), the download module 170 can access the data manager and retrieve a list of any new purchase orders from supplier 110d's trading partners. The download module 170 can then retrieve all or some of those new purchase orders from the data manager 135.

The above-described embodiment of the download module 170 uses a “pull” or “push” method of data transfer. Similarly, the upload module 175 also uses a “push” or “pull” method of data transfer. For example, the data manager 135 could notify the download module 170 that a new document is ready and then push the new document to the download module 170.

The upload module 175 can also parse a document and send the relevant data in a particular format and according to a particular protocol. Alternatively, the upload module 175 can provide data to the data manager 135 in the same general format that is generated by the associated backend system. Although the upload module 175 can format a document for transmission to the data manager, it is not necessarily a translation system. In the preferred embodiment, the upload module 175 navigates any firewalls and transmits data to the data manager 135 through an edge adapter 143 using the data formats native to the trading partner's backend system. The upload module 175 can also provide features to guarantee the security and integrity of the data being transmitted.

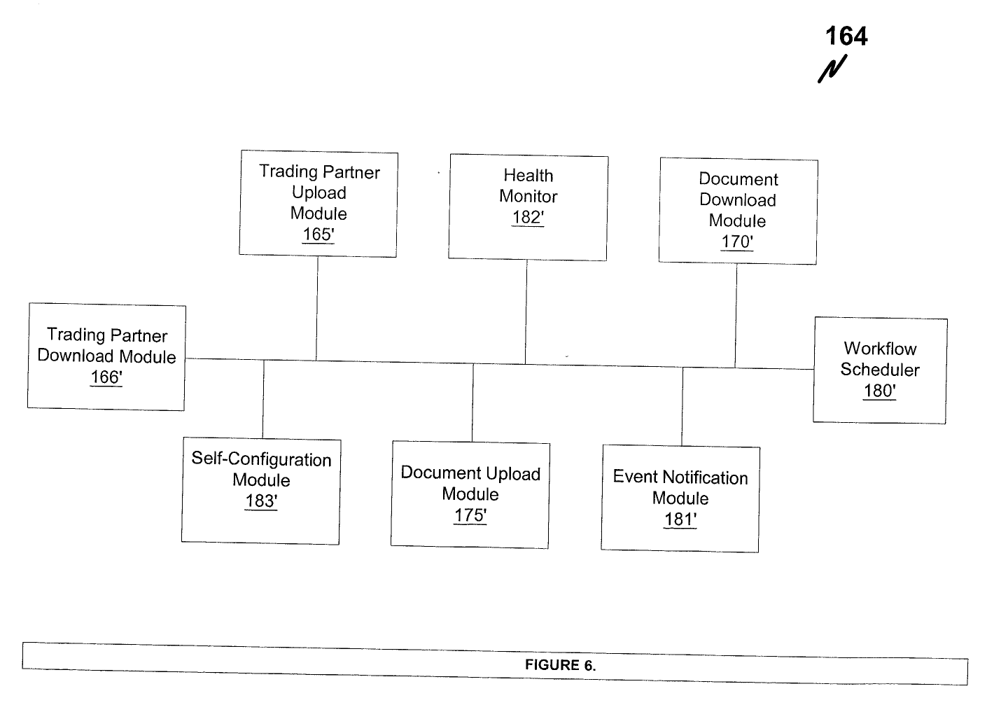

FIG. 6 illustrates an integration module 164 that can be included with a backend system 142. The integration module provides many of the same functions as the client integrator 150. However, for those trading partners that can communicate directly with the data manager 135 rather than through the client integrator 150, many of the functions of the client integrator 150 are incorporated into their backend systems 142. The integration module 164 includes a trading partner module upload module 165′, a trading partner download module 166′, a document download module 170′, a document upload module 175′, a workflow scheduler 180′, an event notification module 181′, a health monitor 182′, and a self-configuration module 183′. In other embodiments, additional and/or alternative modules can be used to construct the same general system.

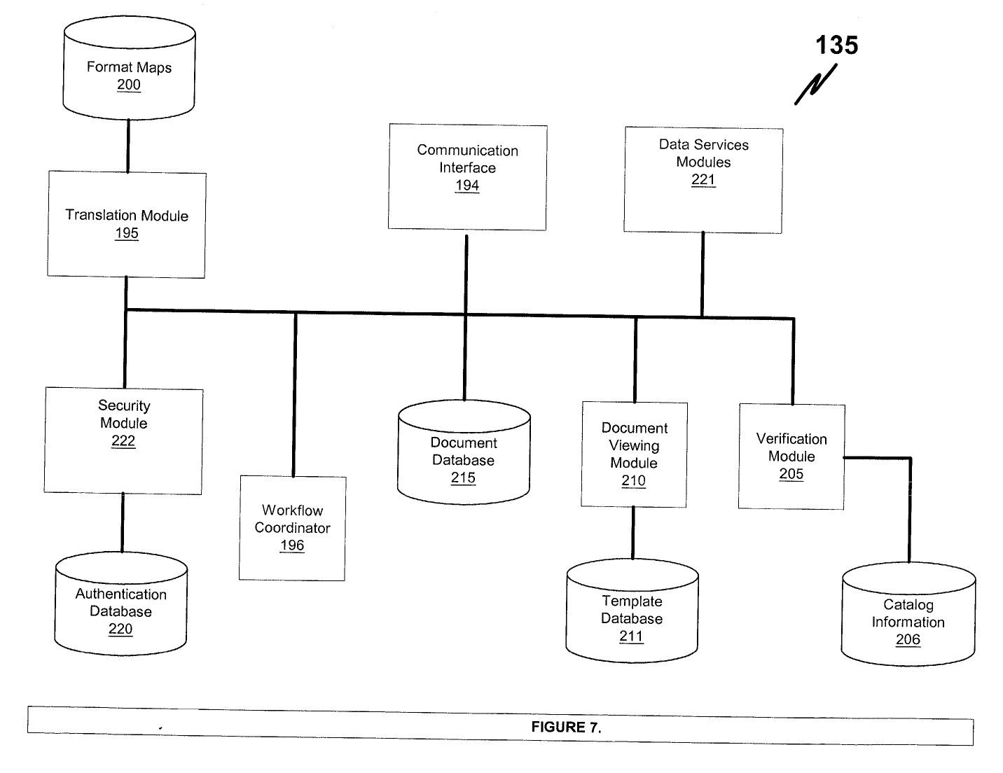

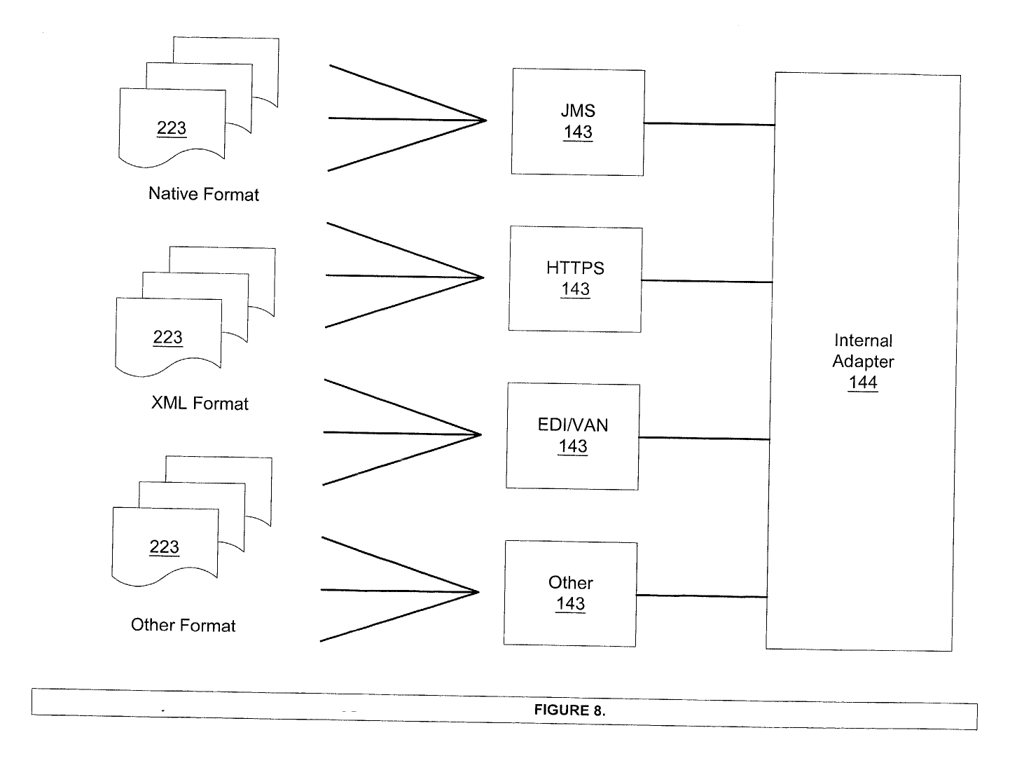

FIG. 7 illustrates one embodiment of the data manager 135, which is responsible for processing, storing and translating documents exchanged by trading partners. The communication interface portion 194 of the data manager 135 is responsible for facilitating this exchange of documents. Although the communication interface 194 could be of almost any type, good results have been achieved using an internal adapter 144 and edge adapters 143 such as shown in FIG. 8. The use of an internal adapter 144 and edge adapters 143 provides the data manager 135 with the ability to receive data from many different types of systems and in many different formats 221. Moreover, the internal adapter 144 provides flexibility to add new trading partners and new adapters.

Once a data exchange has been initiated, the workflow coordinator 196 controls the subsequent processing of that document. For example, the workflow coordinator 196 can initially determine the format of the document, the originating party, the destination party, the document type, and/or the unique identifier. Using this information, the workflow coordinator 196 can determine how the document should be processed and if any special steps are required to process the received document. The workflow coordinator 196 is customizable for each trading partner and/or each document type. In other words, trading partners can establish rules for handling specific events and the workflow coordinator can retrieve and apply those rules. For example, the workflow coordinator 196 may automatically retrieve information from an external data source and initiate the creation of a shipping receipt in response to receiving an order acknowledgement from a particular trading partner. Alternatively, the workflow coordinator 196 may automatically call a routine in the data services module 221 that can generate and send an order approval form to a particular employee of a supplier when an order is over a threshold amount. In yet another embodiment, the workflow coordinator may reject an order with a bad part number.

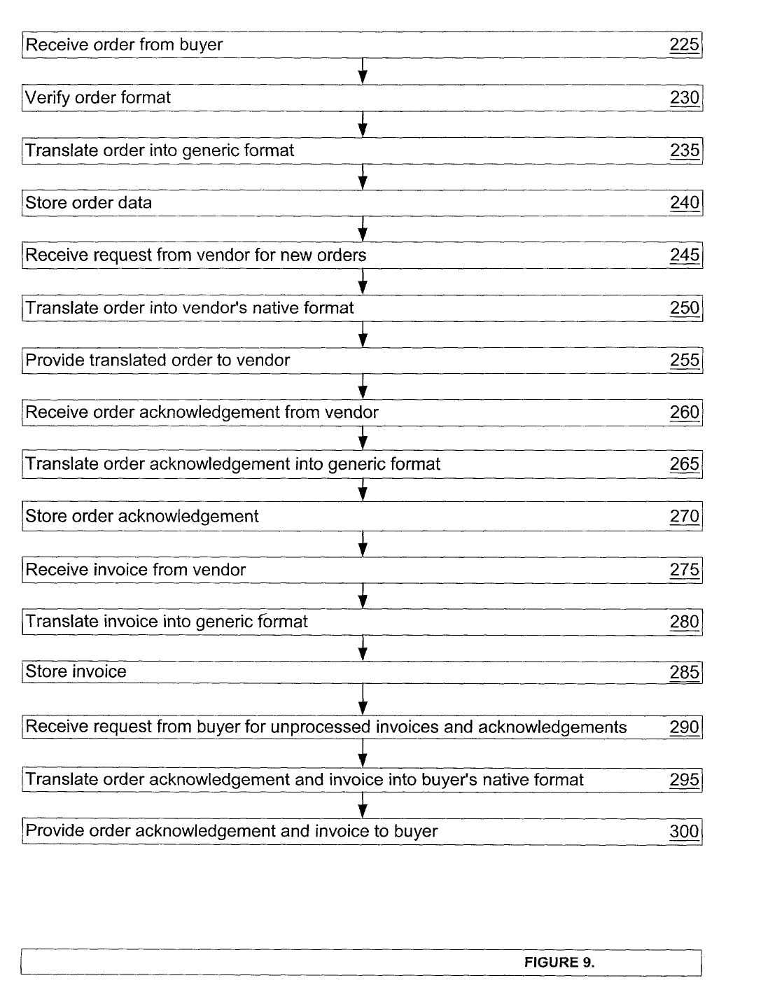

The operation of the workflow coordinator 196 and the interaction of the other components of the data manager 135 are illustrated by reference to the exemplary flowchart in FIG. 9. Initially, the data manager 135 receives a request from the buyer to upload a purchase order (step 225). Once the security module 222 checks the identity and the authorization of the buyer against the authentication database 220, the buyer is permitted to push a purchase order to the data manager 135. (The data manager 135 could instead pull the purchase order.) The verification module 205 can then verify the integrity and/or completeness of the purchase order (step 230). For example, the verification module 205 can do the necessary data validity checks to guarantee that the purchase order was received error free. If the validity checks indicate that an error was introduced into the document during transmission, the data manager 135 can so notify the buyer and/or request retransmission, queue the error for manual intervention, or automatically initiate corrective action.

Additionally, the data manager 135 can verify that the order data contained in the order form is proper. For example, the verification module 205 can compare the product numbers in the purchase order against the relevant supplier's catalog data 206 to verify that the product numbers in the purchase order match actual products. In another embodiment, the verification module 205 can compare the quantity ordered by the purchase order against maximums and minimums required by the supplier. For either of the above cases, however, when a problem is detected, the purchase order can be returned to the buyer along with an appropriate error message, or the data manager 135 could alter the purchase order to reflect its likely intention and so notify the buyer and/or supplier.

After the purchase order has been authenticated and verified, the translation module 195 can translate the purchase order from its native format to a neutral format, such as XML or CBL, and then store the translated document in a document database 215 according to, for example, the originating party, the destination party, and/or the document type (steps 235 and 240). To achieve this translation, the translation module 195 accesses a database of format maps 200 that define the process for translating documents from their native format to the neutral format. Each trading partner (or document types associated therewith) can be associated with a particular format map, thereby allowing each trading partner to use their own document formats without regard for the destination trading partner. An advantage of translating to a neutral format is that the number of translation maps needed for a particular trading partner is not impacted by the number of other trading partners.

With the purchase order translated and stored, it is now available to the supplier through the document download module 185 in the data manager 135. The purchase order can be pushed to the supplier, or it can be pulled by the supplier (step 245). In either embodiment, however, the purchase order generally is first translated from the neutral format to the supplier-specific format by using a format map associated with the particular supplier and possibly that particular document (step 250). Next, the translated purchase order can be provided directly to the supplier (step 255). Notably, the purchase order is in a format that can be accepted by the supplier's backend system. There is no need for the supplier to manually enter the information from the purchase order into its backend system.

Responsive to receiving the purchase order, the supplier can generate an order acknowledgement and/or an invoice and send them to the data manager 135 where they can be verified, authenticated and translated into the neutral format (steps 260, 265, 270, 275, 280, and 285) in a fashion similar to that described above. The order acknowledgement and the invoice can next be translated from the neutral format to the buyer-specific format and then provided to the buyer (steps 290, 295, and 300). At this point, the data received by the buyer should be in a format that can be directly accepted by the buyer's backend system. Accordingly, the buyer should not be forced to manually enter the data from the invoice and the order acknowledgement into its backend system.

Although the operation of the data manager 135 is described with relation to documents such as purchase orders, order acknowledgements and invoices, the system and its operation can be easily adapted to handle any type of data passed between enterprises. For example, the present invention can be configured to handle insurance claims, payroll accounts, service requests, requirements documents, work orders, photographs, binary files, audio files, images, x-rays, etc.

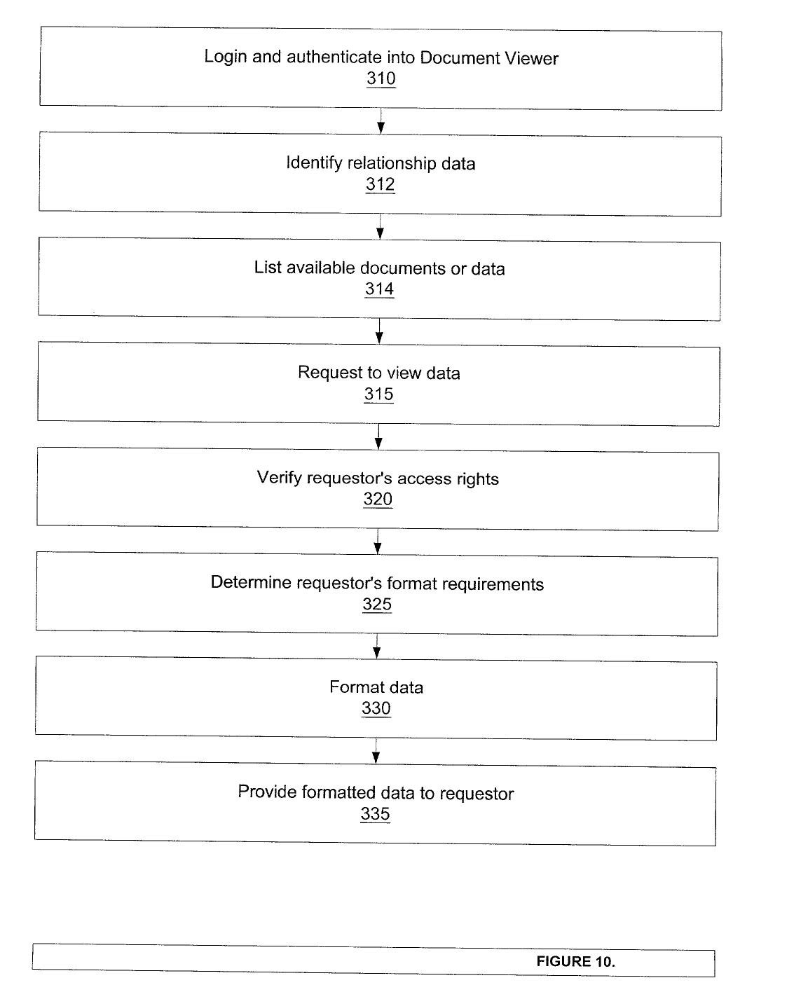

Referring now to FIG. 10, it is a flowchart of a method for operating the document viewer 147 and the corresponding document viewing module 210 (shown in FIG. 7). The document viewer 147 allows individuals or users associated with trading partners to exchange, sort, track and view relevant documents and data. Initially, a user must login (step 310) and authenticate to the data manager 135 via the document viewer 147. Based upon the user's authenticated identity, the document-viewing module 210 retrieves relationship data associated with that user's trading partner (step 312). This relationship data defines what data can be viewed, personal viewing preferences, last activity, etc. For example, a shipping employee could be permitted to view shipping receipts but not invoices.

After the user has logged in and the relationship data identified, he can be shown a list of documents available for viewing (step 314). The user can then select a document to view from one of the trading relationships to which he has access. The document-viewing module 210 then retrieves a format map, also called a “style sheet,” from the template database 211 and the data for that document is formatted accordingly (steps 325 and 330). Format maps can be configured at a user-level or shared across user roles. The document is then displayed in a familiar format despite the document's original format (step 335). The format map can also filter the document data so that a user may be able to view only specific fields of a document. For example, a shipping employee could be blocked from viewing pricing information included on shipping receipt.

In another embodiment, the document-viewing module 210 can add additional content to a document based upon a user's role. The document viewer, for example, can add action buttons to certain documents when viewed by people with the proper authorization. These action buttons, when activated, can call an external application. For example, the document-viewing module 210 can add “accept/deny” action buttons to invoices when they are viewed by personnel in accounts receivable. When the action is activated, the appropriate routine in the trading partner's backend system can be called. Alternatively, a routine within a hosted application can be called.

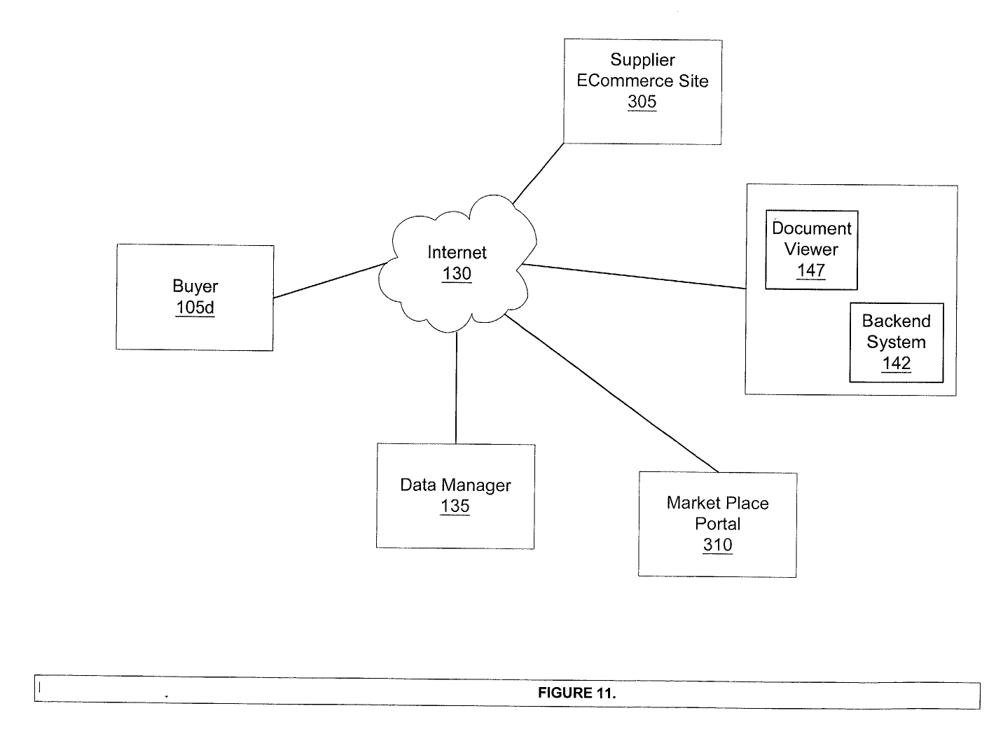

Referring now to FIG. 11, it illustrates a system for web-originating ordering in accordance with the principles of the present invention. In this embodiment, the buyer 105d enters an order through the supplier's web site 305 or through a market place portal 310. Alternatively, the buyer could place an order through traditional means such as by calling in or faxing in the order. In either case, however, the order from the buyer generally does not originate from (and/or is not entered into) the buyer's backend system 142.

Once an order is placed, the order data (possibly in the form of an order acknowledgement or an invoice) is then forwarded to the data manager 135 where it is translated and processed into the neutral format and stored. Using the web-originated order data, the data manager 135 can generate a purchase order in the buyer's native format and provide that purchase order to the buyer 105d so that the purchase order can be automatically loaded into the buyer's backend system 142. If necessary, the data manager 135 can also provide the purchase order to the supplier's backend system 142.

Thus, even though the buyer 105d ordered the product from the supplier's web site 305, the buyer's backend system treats the order as if it were made through traditional channels, i.e., through a standard purchase order. The buyer 105d is not required to enter the same information (already entered into the supplier's web site 305) into its own backend system.

The supplier also routes any response documents for the web-originated order to the data manager 135 rather than (or in addition to) returning them to the buyer through email or some other method. Thus, the buyer 105d can retrieve the order acknowledgement and invoice for a web-originated order in the same fashion as if the order had been initially entered into the buyer's backend system.

Although the components of the present invention can be implemented in most any programming language and on most any hardware system, good results have been achieved by implementing the client integrator 150 on an Intel-based machine in a Perl and Java language. Additionally, good results have been achieved by implementing the data manager 135 in Java on Java 2 Enterprise Edition (J2EE) compliant application servers with underlying Sun Microsystems hardware. The use of these systems and programming languages reflects a design choice. Good results have been achieved using a variety of interconnected data models within Oracle RDBMS data-warehouses and data-marts. Accordingly, the present invention could be implemented in various languages and on various platforms.

In this document, the term “computer program product” is used to refer to any media that may be used to provide programming instructions or data to a processing system (not shown), or to any server or processor within the processing system. Examples of such media include any memory products used by or within the system, any storage drives or devices (whether fixed or removable) used by or within the system, and any signals that may be transmitted to, from, or within the system.

In conclusion, the present invention provides, among other things, a system and method for efficiently integrating non-homogenous business systems. Those skilled in the art, however, can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing orders placed at an electronic commerce site, the method comprising:
receiving, from the electronic commerce site, at least an indication of a purchase order originated by a buyer;
converting the at least an indication of the purchase order to a buyer-native-format purchase order; and
electronically providing the buyer-native-format purchase order to the buyer.

2. The method of claim 1, wherein the receiving at least an indication of the purchase order comprises:
receiving an indication of the purchase order through an order acknowledgement form.

3. The method of claim 1, wherein the converting comprises:
converting the at least an indication of the purchase order to a neutral-format purchase order; and
converting the neutral-format purchase order to the buyer-native-format purchase order.

4. The method of claim 3, wherein the converting further comprises:
retrieving a first translation map, wherein the first translation map corresponds to the electronic commerce site and wherein the first translation map is useable for converting the at least an indication of the purchase order to the neutral-format purchase order; and
retrieving a second translation map, wherein the second translation map corresponds to the buyer and wherein the second translation map is useable for converting the neutral-format purchase order to the buyer-native-format purchase order.

5. The method of claim 1, further comprising:
receiving, from the electronic commerce site, an order acknowledgement corresponding to the received at least an indication of a purchase order;
converting the order acknowledgement to a buyer-native-format order acknowledgement; and
electronically providing the buyer-native-format order acknowledgement to the buyer.

6. The method of claim 1, further comprising:
receiving, from the electronic commerce site, an invoice corresponding to the received at least an indication of a purchase order;
converting the invoice to a buyer-native-format invoice; and
electronically providing the buyer-native-format invoice to the buyer.

7. The method of claim 1, further comprising:
converting the at least an indication of the purchase order to a supplier-native-format purchase order; and
electronically providing the supplier-native-format purchase order to the supplier;
wherein the supplier is associated with the electronic commerce site.

8. The method of claim 7, further comprising:
receiving a response document associated with the provided supplier-native-format purchase order;
converting the received response document to a neutral format;
converting the neutral format of the response document to a buyer-specific format;
electronically providing the buyer-native-format of the response document to the buyer.

9. A method for managing orders placed at a document collection system, the method comprising:
providing a purchase order to an order collection system;
receiving, from a data manager, a buyer-native-format purchase order, wherein the buyer-native-format purchase order is the product of a conversion between a first format and a buyer-native-format; and
integrating the received buyer-native-format purchase order into a backend system associated with the buyer.

10. The method of claim 9, further comprising:
providing at least an indication of the purchase order from the electronic commerce site to a data manager.

11. The method of claim 10, further comprising:
converting the at least an indication of the purchase order to the buyer-native-format purchase order; and
electronically providing the buyer-native-format purchase order to the buyer

12. The method of claim 10, wherein the converting comprises:
converting the at least an indication of the purchase order to a neutral-format purchase order; and
converting the neutral-format purchase order to the buyer-native-format purchase order.

13. The method of claim 9, wherein the providing the purchase order comprises:
providing the purchase order to a web site.

14. The method of claim 9, wherein the step of providing the purchase order comprises:
providing the purchase order to an electronic marketplace portal.

15. The method of claim 9, further comprising:
receiving a buyer-native-format order acknowledgement, wherein the buyer-native-format order acknowledgement is the product of a conversion between an electronic-commerce-site-format order acknowledgement and a buyer-native-format order acknowledgement; and
integrating the received buyer-native-format order acknowledgement into the backend system associated with the buyer.

16. The method of claim 15, further comprising:
receiving a buyer-native-format invoice, wherein the buyer-native-format invoice is the product of a conversion between an electronic-commerce-site-format invoice and a buyer-native-format invoice; and
integrating the received buyer-native-format invoice into a backend system associated with the buyer.

17. The method of claim 9, wherein the receiving, from a data manager, a buyer-native-format purchase order, comprises:
receiving, from a data manager integrated with the electronic commerce site, a buyer-native-format purchase order.

18. The method of claim 9, wherein the receiving, from a data manager, a buyer-native-format purchase order, comprises:
receiving, from a data manager independent from the electronic commerce site, a buyer-native-format purchase order.

19. A method for managing data provided at a document collection system, the method comprising:
receiving at least an indication of a document originated by a originating party; and
forwarding the at least an indication of the document to a data manager to thereby enable the data manager to:
converting the at least an indication of the document to a originating party-native-format purchase order; and
electronically providing the originating party-native-format purchase order to the originating party.

20. A method for managing data provided to a document collection system, the method comprising:
receiving at least an indication of a document originated by an originating party; and
forwarding the at least an indication of the document to a data manager to thereby enable the data manager to:
convert the at least an indication of the document to a neutral-format document; and
convert the neutral-format document to the originating party-native-format document; and
electronically provide the originating party-native-format purchase order to the originating party.

21. A method for managing a document provided to a document collection system, the method comprising:
receiving, from the order collection system, at least an indication of a document originated by an originating party;
converting the at least an indication of the document to a originating party-native-format document; and
electronically providing the originating party-native-format document to the originating party.

22. The method of claim 21, wherein the converting comprises:
converting the at least an indication of the document to a neutral-format document; and
converting the neutral-format document to the originating party-native-format document.

23. The method of claim 22, wherein the converting further comprises:
retrieving a first translation map, wherein the first translation map corresponds to the electronic commerce site and wherein the first translation map is useable for converting the at least an indication of the document to the neutral-format document;
retrieving a second translation map, wherein the second translation map corresponds to the originating party and wherein the second translation map is useable for converting the neutral-format document to the originating party-native-format document;
converting the invoice to a originating party-native-format invoice; and
electronically providing the originating party-native-format invoice to the originating party.

24. A system for managing documents provided to a document collection system, the system comprising:
at least a first processor;
at least a first storage device connected to the at least a first processor; and
a plurality of instructions stored on the at least a first storage device, the plurality of instructions configured to cause the at least a first processor to:
receive, from the document collection system, at least an indication of a document originated by an originating party;
convert the at least an indication of the document to an originating party-native-format document; and
electronically provide the originating party-native-format document to the originating party.

25. The system of claim 24, wherein the plurality of instructions are further configured to cause the at least a first processor to convert the at least an indication of the document by:
converting the at least an indication of the document to a neutral-format document; and
converting the neutral-format document to the originating party-native-format document.

26. The system of claim 24, wherein the plurality of instructions are further configured to cause the at least a first processor to convert the at least an indication of the document by:
retrieving a first translation map, wherein the first translation map corresponds to the electronic commerce site and wherein the first translation map is useable for converting the at least an indication of the document to the neutral-format document;
retrieving a second translation map, wherein the second translation map corresponds to the originating party and wherein the second translation map is useable for converting the neutral-format document to the originating party-native-format document.
converting the invoice to an originating party-native-format invoice; and
electronically providing the originating party-native-format invoice to the originating party.

33. A system for facilitating an exchange of data, the system comprising:
a format map storage device configured to store a plurality of translation format maps;
a translation module in communication with the format map storage device, the translation module configured to receive a data item, translate the data item to a neutral format according to a first of the plurality of translation format maps, and translate the neutral format of the data item to a destination-party-specific format according to a second of the plurality of translation format maps; and
a document data base in communication with the translation module, the document database configured to store the neutral format of the data item.

34. The system of claim 33, further comprising:
a workflow coordinator configured to initiate processing of the received data item.

35. The system of claim 34, further comprising:
a product information database configured to store product information; and
a verification module in communication with the workflow coordinator and the product information database;
wherein the verification module is configured to compare product information included with the received data item and product information stored in the product information database.

36. The system of claim 33, further comprising:
a document viewing module; and
a style sheet storage device in communication with the document viewing module, the style sheet storage device configured to store a plurality of style sheets;
wherein the document viewing module is configured to graphically render the received data item according to a first of the plurality of style sheets.

37. The system of claim 33, further comprising:
a first edge adapter for communicating with a first client in a first client-native method;
a second edge adapter for communicating with a second client in a second client-native method; and
an internal adapter coupled to the first edge adapter and the second edge adapter, the internal adapter configured to communicate with the first edge adapter according to the first client-native method and to communicate with the second edge adapter according to the second client-native method.

38. The system of claim 37 wherein the internal adapter is further configured to communicate with the translation module according to an internal method.
